(19) United States
(12) Patent Application Publication
(10) Pub. No.: US 2009/0061891 A1
(43) Pub. Date: Mar. 5, 2009

(54) Method for requesting rescue by receiving disaster alarm signal and apparatus thereof

(75) Inventor: Ta-Sik Chung, Seongnam-si (KR)

Correspondence Address: HARNESS, DICKEY & PIERCE, P.L.C., P.O. BOX 8910, RESTON, VA, 20195, US

(73) Assignee: KTF TECHNOLOGIES, INC.

(21) Appl. No.: 12/073,624

(22) Filed: Mar. 7, 2008

(30) Foreign Application Priority Data
Aug. 27, 2007 (KR) 10-2007-0086228

(51) Int. Cl. H04Q 7/20; G01S 1/00

(52) U.S. Cl. 455/456.1; 342/357.1

(57) ABSTRACT

A method of requesting a rescue by receiving a disaster alarm signal and a method thereof are disclosed. The method of requesting a rescue by a user terminal, which is connected to a disaster informing server and a rescue center through a communication network, can include receiving a disaster alarm signal from the disaster informing server, generating a corresponding RF signal by receiving the disaster alarm signal, and outputting the generated RF signal. The rescue center can position the user terminal by analyzing an RF response signal sent from a movable rescue apparatus including an RF module for receiving the RF signal.

### CROSS-REFERENCE TO RELATED PATENT APPLICATIONS

This application claims the benefit of Korean Patent Application No. 10-2007-0086228, filed on Aug. 27, 2007, in the Korean Intellectual Property Office, the disclosure of which is incorporated herein in its entirety by reference.

### BACKGROUND OF THE INVENTION

1. Field of the Invention

The present invention relates to a method for requesting a rescue when a disaster occurs, more specifically to a method for requesting a rescue by using a user terminal when a disaster occurs.

2. Background Art

Thanks to today's popularity of mobile communication terminals, consumers now consider the mobile communication terminals as one of their necessities. Also, the developing mobile communication service makes it possible not only to exchange written messages or voice calls but also to position a terminal user.

However, since it has been difficult to accurately position a terminal holder in the conventional art, the position has been received in units of cell radius of the mobile phone base station. Also, since it has been impossible to accurately represent the position of a user through the terminal, the rescue would be delayed even through the user requested the emergency rescue. Accordingly, it has been impossible to provide a prompt and accurate service when a terminal subscriber requested an emergency rescue. Also, since it is easy that a user in danger is unable to know the exact location where the user is, the user may not represent his or her position accurately in an emergency situation.

Also, in accordance with the conventional art, it has been necessary that the user in an emergency situation informed the outside that a disaster occurred through a simple manipulation (e.g. input of an emergency button). However, it could be difficult that the user in the emergency situation made even the simplest manipulation. It may be also difficult, if not impossible, for the user to manipulate the terminal if an ill-fate of the accident separates the terminal from the user.

### SUMMARY OF THE INVENTION

The present invention, which is contrived to solve the aforementioned problems, provides a method for requesting a rescue by using a disaster alarm signal and an apparatus thereof.

In other words, if a disaster hits a terminal user, the present invention allows his or her terminal to output an RF signal having a predetermined frequency band and a rescuer having an RF module capable of receiving the predetermined frequency band to accurately position the pertinent terminal.

Also, the present invention rescues a terminal user in danger easily by allowing a terminal to receive a disaster alarm signal and to output an RF signal automatically without the user's button manipulation.

Other problems that the present invention solves will become more apparent through the following description.

An aspect of the present invention features a method for requesting a rescue when a disaster occurs.

In accordance with an embodiment of the present invention, the method of requesting a rescue by a user terminal connected to a disaster informing server and a rescue center through a communication network includes: receiving a disaster alarm signal from the disaster informing server; generating a corresponding RF signal by receiving the disaster alarm signal; and outputting the generated RF signal. The rescue center positions the user terminal by analyzing an RF response signal sent from a movable rescue apparatus including an RF module for receiving the RF signal.

In the step of receiving the disaster alarm signal, the disaster alarm signal is received by using a cell broadcasting server.

In the step of generating the RF signal, the RF signal includes a rescue message.

The rescue message includes position information of the user terminal.

The position information of the user terminal is extracted by using a GPS signal received from a global positioning system (GPS) satellite.

The RF signal has a predetermined frequency band.

The predetermined frequency band is not used for mobile communication.

The rescue center pre-acquires a position of the user terminal in units of base station by receiving the disaster alarm signal from the disaster informing server.

In the method of allowing the rescue center to position the user terminal, the rescue center generates position information of the user terminal by using the difference between transmission time information related to a time when the RF signal is transmitted and reception time information related to a time when a movable rescue apparatus receives the RF signal. The transmission time information and the reception time information are included in the RF response signal received from the movable rescue apparatus at a periphery of the user terminal.

The RF response signal has a magnitude of the RF signal, and the rescue center generates position information of the user terminal by measuring a distance between the user terminal and the movable rescue apparatus according to the magnitude of the RF signal received from the movable rescue apparatus at a periphery of the user terminal.

The magnitude of the RF signal is inversely proportional to any one variable among the square of the distance between the user terminal and the movable rescue apparatus, the cube of the distance between the user terminal and the movable rescue apparatus, and the distance between the user terminal and the movable rescue apparatus, multiplied to the fourth power.

The RF response signal has phase information of the RF signal, and the rescue center generates position information of the user terminal according to the phase information of the RF signal.

The number of movable rescue apparatuses is three.

Another aspect of the present invention features a terminal requesting a rescue when a disaster occurs.

An embodiment of the present invention provides a terminal connected to a disaster informing server and a rescue center through a communication network. The terminal includes: a signal receiving unit, receiving a disaster alarm signal from the disaster informing server; an RF signal generating unit, generating an RF signal having a predetermined frequency band according to the received disaster alarm signal; an RF signal output unit, outputting the generated RF signal; and a terminal control unit, controlling generation and output of the RF signal.

The terminal also has a position information generating unit generating position information of the user terminal.

The position information generating unit generates the position information by using a GPS signal received from a global positioning system (GPS) satellite.

The signal receiving unit receives the disaster alarm signal by using a cell broadcasting server.

The predetermined frequency band is not used for mobile communication.

### BRIEF DESCRIPTION OF THE DRAWINGS

These and other features, aspects and advantages of the present invention will become better understood with regard to the following description, appended Claims and accompanying drawings where:

FIG. 1 is a simplified diagram illustrating a mobile communication system in accordance with an embodiment;

FIG. 2 is a simplified block diagram illustrating a terminal in accordance with an embodiment of the present invention;

FIG. 3 is a flow chart illustrating a method of outputting an RF signal in a user terminal in accordance with an embodiment of the present invention;

FIG. 4 illustrates a position information generating method of a user terminal using a movable rescue apparatus in accordance with another embodiment of the present invention; and

FIG. 5 is a flow chart illustrating a method of rescuing a rescuee in accordance with an embodiment of the present invention.

### DESCRIPTION OF THE EMBODIMENTS

Since there can be a variety of permutations and embodiments of the present invention, predetermined embodiments will be illustrated and described with reference to the accompanying drawings. This, however, is by no means to restrict the present invention to predetermined embodiments, and shall be construed as including all permutations, equivalents and substitutes covered by the spirit and scope of the present invention.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe predetermined embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a predetermined technology is determined to evade the point of the present invention, the pertinent detailed description will be omitted.

Hereinafter, some embodiments of the present invention will be described in detail with reference to the accompanying drawings.

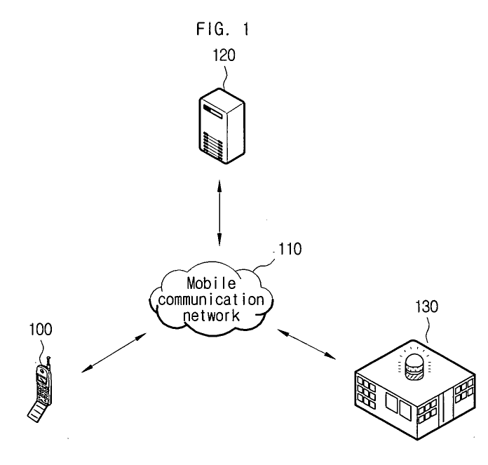

FIG. 1 is a simplified diagram illustrating a mobile communication system in accordance with an embodiment.

Referring to FIG. 1, the mobile communication system in accordance with an embodiment of the present invention can include a user terminal 100, a disaster informing server 120, a rescue center 130 and a mobile communication network 110 connecting each element.

The user terminal 100 can be a personal digital assistant (PDA), a cellular phone, a personal communication service (PCS) phone, a hand-held PC, a global system for mobile (GSM) phone, a wideband CDMA (W-CDMA) phone, a CDMA-2000 phone and a mobile broad or a system (MBS) phone. These types can be selected according to the type of the mobile communication system constituting the mobile communication network 110. Here, the MBS phone indicates the cellular phone to be used in the currently discussed fourth generation system.

The user terminal 100 can include an RF module for automatically receiving a disaster alarm signal without user's direct manipulation (e.g. input of emergency button) and outputting a radio frequency (hereinafter, referred to as “RF”) signal for requiring a rescue.

Here, RF refers to a wireless frequency, particularly, the frequency used for wireless communication. The RF module, which is the module processing the RF signal, is used to generate and receive a wireless signal. For example, the RF module can be a duplexer, a dual duplexer and a filter bank, including a filter and phase-modulator. At this time, the filter bank refers to the device in which a plurality of filters allowing a wavelength having a predetermined band only to pass through are modulated, and the duplexer refers to the device that suitably separate a transmitted signal and a received RF signal through an antenna by complexly using a filter.

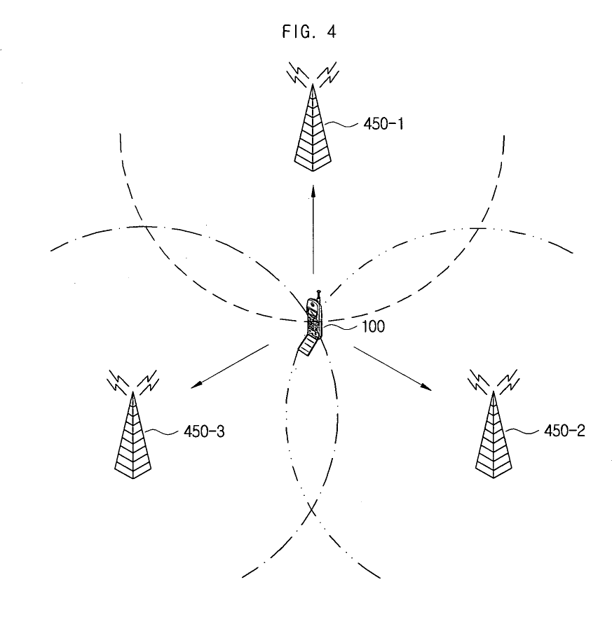

The mobile communication network 110 can include a wireless base station, a mobile switching center (MSC) and a data core network and be connected to the user terminal 100 and the rescue center 130. Also, in case that the user terminal 100, which has been connected to the disaster informing server 120 and has received a disaster alarm signal from the disaster informing server 120, outputs an RF signal having a predetermined frequency band informing the disaster, the rescue center 130 can receive the RF signal from the user terminal 100 by using a movable rescue apparatus having the RF module for receiving the pertinent output signal and performs related processes for prompt rescue by positioning the user terminal 100 by use of the output magnitude and received and transmitted times of the RF signal. The method of using the movable rescue apparatus will be described with reference to FIG. 4.

In other words, if the user terminal 100 outputs an RF signal having a predetermined frequency band, the mobile communication network 110 can transmit and receive the pertinent RF signal to and from the rescue apparatus having the RF module capable of receiving the RF signal.

Here, the predetermined frequency band can be the frequency band which is not used for the mobile communication. In other words, in spite of using no commercial frequency or any commercial frequency, it is possible to give no confusion to users by using the frequencies within the guard band.

In accordance with another embodiment of the present invention, the user terminal 100 can output an RF signal including a rescue message. Here, the rescue message can include position information informing a position where the rescuee is currently requiring a rescue.

The disaster informing server 120 can be separately located per section. If a disaster occurs per separated section, the disaster informing server 120 transmits a disaster alarm signal by the wireless communication. Here, the disaster informing server 120 can be realized as a dedicated server that is separately provided to inform that the disaster occurs or as a module that is located at a part of an existing server performing other functions to inform that the disaster occurs.

The disaster alarm signal can be also transmitted through the conventional cell broadcasting service method. Here, the cell broadcasting service refers to the service simultaneously transmitting a message to mobile communication user terminals within a predetermined range from a message input device or mobile communication user terminals of predetermined groups by using a paging channel among wireless channels of a base station. Since the cell broadcasting service technology, which is the known technology, is evident to any person of ordinary skill in the art, the pertinent detailed description will be omitted.

The rescue center 130 can be a computer device that is equipped in the all kinds of emergency rescue centers or movable rescue centers. The rescue center 130 can transmit and receive information to and from the movable rescue apparatus and recognize the position of the user terminal 100 by controlling the information. Herein, the movable rescue apparatus can include the RF module capable of receiving the RF signal including the rescue message outputted from the user terminal 100 when the disaster occurs. The movable rescue apparatus 450 can be a separate establishment or vehicle having the RF module. In other words, when the disaster occurs, in the case of receiving the disaster alarm signal from the disaster informing server 120, the movable rescue apparatus 450 can roughly position the user terminal 100, and after approximating to the user terminal 100, can accurately position the user terminal 100.

The below description is mainly related to the case that the rescue center is a movable device (e.g. a 911 ambulance or a fire truck).

However, the case by no means restricts the rescue center 130. Alternatively, it is obvious that any unmovable building (e.g. a fire station or an emergency rescue center) capable of positioning the user terminal 100 by using the movable rescue apparatus 450 including the RF module is applicable to the present invention.

In accordance with an embodiment of the present invention, the disaster informing server 120 can transmit a disaster alarm signal to the user terminal 100 within a pre-divided section, and the user terminal 100, which has received the disaster alarm signal, can generate and output an RF signal having a predetermined frequency band. The rescue center 130 can receive the RF signal having the predetermined frequency band transmitted from the user terminal 100 by using a movable rescue apparatus having an RF module capable of a pertinent RF signal outputted from the user terminal 100. The rescue center 130 can perform the related process for rescuing a user in danger by receiving an RF response signal from the movable rescue apparatus and positioning the user terminal 100.

In other words, a rescue can be requested without user's manipulation by allowing the user terminal 100, which has received a disaster alarm signal, to automatically generate and output an RF signal. Also, if the user is not in danger, the user can stop allowing the user terminal 100 to output the RF signal through key input of the user terminal 100.

In accordance with another embodiment of the present invention, the user terminal 100, which has received a disaster alarm signal from the disaster informing server 120, can generate position information by using a global positioning system (GPS) unit equipped in the user terminal 100 by itself and transmit the generated position information to the rescue center 130.

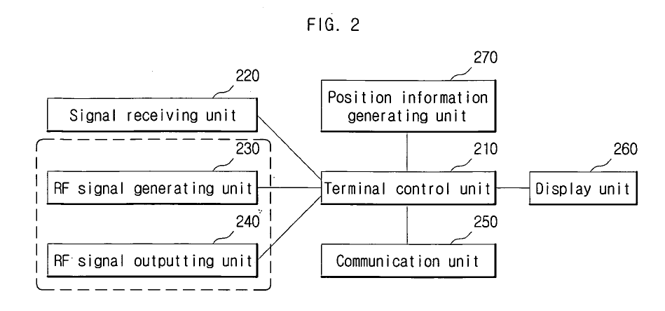

FIG. 2 is a simplified block diagram illustrating a terminal in accordance with an embodiment of the present invention.

Referring to FIG. 2, in accordance with an embodiment of the present invention, the user terminal 100 can be configured to include a terminal control unit 210, a signal receiving unit 220, an RF signal generating unit 230, an RF signal output unit 240, a communication unit 250 and a display unit 260. Also, the user terminal 100 can further include a position information generating unit 270.

The terminal control unit 210 can control a general operation of the user terminal 100. In particular, the terminal control unit 120 can control the operations of the user terminal 100 by allowing the user terminal 100 to receive a disaster alarm signal from the disaster informing server 120, to generate an RF signal and to output the RF signal having a predetermined frequency band to the rescue center 130 having an RF module in order to inform the position of the user terminal 100.

The signal receiving unit 220 can receive the disaster alarm signal transmitted from the disaster informing server 120 and transmit the received disaster alarm signal to the terminal control unit 210. The terminal control unit 210 can receive the disaster alarm signal from the signal receiving unit 220, recognize that the user terminal 100 is in danger and transmit a command of generating an RF signal having a predetermined frequency band to the RF signal generating unit 230 to inform that the user terminal 100 is in danger.

The RF signal generating unit 230 can receive the command of generating the RF signal from the terminal control unit 210 and generate the RF signal in order to transmit the generated RF signal to the rescue center 130 having an RF module according to the control of the terminal control unit 210. Here, the generated RF signal can include a rescue message. Alternatively, in accordance with another embodiment of the present invention, an RF signal having a predetermined frequency band without additional message can be generated to simply inform the disaster. In this case, the generated RF signal can be a very simple signal such as Morse code. Also, the RF signal can be generated to have very little magnitude in order to use the battery at a minimum.

The RF signal output unit 240 can output the RF signal generated by the RF signal generating unit 230. The RF signal generating unit 230 and the RF signal output signal 240 can be realized as each module separately or as one RF module inclusively.

The communication unit 250 can transmit and receive signals to and from each apparatus connected through the user terminal 100 and the communication network 110 (e.g. the disaster informing server 120 or the rescue center 130). Particularly, the terminal control unit 210 can receive a disaster alarm signal from the disaster informing server 120 though the communication unit 250 and allow the user terminal 100 to output the RF signal. Here, the communication unit 250 can further include a modem, an antenna and a signal amplifier capable of modulating/demodulating signals in a predetermined format.

The display unit 260 can allow a user to visionally recognize each received data by displaying the data to an outside. Herein, the display unit 260 can employ a Liquid crystal display (LCD) or a plasma display panel (PDP).

In accordance with another embodiment of the present invention, the user terminal 100 can further include the position information generating unit 270.

The position information generating unit 270 can include a global positioning system (GPS) unit (not shown) and receive GPS signals from GPS satellites (i.e. 27 satellites including 3 supplement satellites). The position information generating unit 270 can also generate position information related to the current position of the user terminal 100 by using the GPS signal in order to transmit the generated position information to the terminal control unit 210. In particular, the position information generating unit 270 can generate the position information according to a position information generating command.

In other words, if the position information generating command is received, the position information generating unit 270 can generate the position information related to a place at which the user terminal 100 is currently located. Here, the position information generating unit 270 can use a differential GPS (D-GPS) to minimize an error range. Since the method of generating the position information in the position information generating unit 270 is evident to any person of ordinary skill in the art, the pertinent detailed description will be omitted.

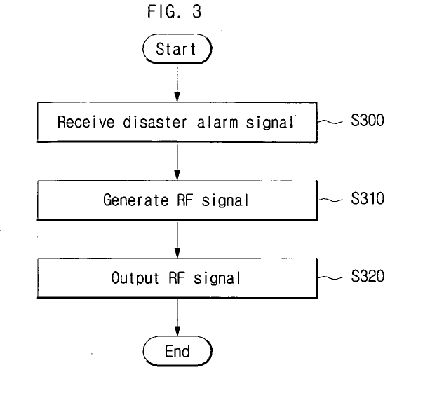

FIG. 3 is a flow chart illustrating a method of outputting an RF signal in a user terminal in accordance with an embodiment of the present invention.

The method of outputting an RF signal in the user terminal 100 in accordance with an embodiment of the present invention will be described in detail with reference to FIG. 3. Although each step to be described below may be the steps to be performed in each element included in the user terminal 100, the steps are assumed to be performed in the user terminal 100 for the convenience of understanding and description. Accordingly, the subject which performs each step to be described below may be omitted as the user terminal 100.

In a step represented by S300, the user terminal 100 can receive a disaster alarm signal from the disaster informing server 120. The user terminal 100 can receive the disaster alarm signal from the disaster informing server 120 through the mobile communication network 110. As described above, the user terminal can also receive the disaster alarm signal through a cell broadcasting service.

Here, the disaster alarm signal can include a disaster alarm message, and the disaster alarm message can include the disaster type (e.g. a fire, an earthquake, a typhoon and a heavy rain.

In a step represented by S310, the user terminal 100, which has received the disaster alarm signal, can generate an RF signal having a predetermined frequency band. The RF signal can be generated by the RF signal generating unit 230 according to an RF signal generating command of the terminal control unit 210. Here, the generated RF signal can be the RF signal having the predetermined frequency band indicating rescue request. At this time, the predetermined frequency band can be the frequency band which is not used for the mobile communication. In other words, in spite of using no commercial frequency or any commercial frequency, it is possible to give no confusion to users by using the frequencies within the guard band.

In accordance with another embodiment of the present invention, the RF signal outputted from the user terminal 100 can include a rescue message, and the rescue message can include a rescue requiring message and a disaster alarm message, received from the disaster informing server 120.

In a step represented by S320, the user terminal 100 can output the generated RF signal. The RF signal output unit 240 can receive and output the RF signal generated by the RF signal generating unit 230 according to the control of the terminal control unit 210. Here, it is natural that the RF signal generating unit 230 and the RF signal output unit 240 can be realized as one module inclusively instead of separate modules.

The RF signal outputted from the user terminal 100 can be transmitted to a movable rescue apparatus having an RF module, and the movable rescue apparatus can compute position information of the user terminal 100 by sending an RF response signal to the rescue center 130. In accordance with another embodiment of the present invention, the user terminal 100 can send the RF signal including the current position information of the user terminal 100 to rescue center 130 by itself by mounting a global positioning system therein.

Accordingly, a user in danger can inform surroundings of his or her emergency situation without additional manipulation of the user terminal 100 and easily receive the rescue of the rescue center 130 by transmitting and receiving the RF signal through the RF module.

FIG. 4 illustrates a position information generating method of a user terminal using a movable rescue apparatus in accordance with another embodiment of the present invention.

The movable rescue apparatuses 450-1, 450-2 and 450-3 (hereinafter, collectively referred to as 450) including an RF signal module capable of receiving an RF signal having a predetermined frequency band can receive an RF signal having a predetermined frequency band from the user terminal 100 in order to compute position information related to the current position of the user terminal 100.

The rescue center 130 can compute the position information of the user terminal 100 by analyzing at least 3 signals received from a first movable rescue apparatus 450-1, which has received the RF signal from the user terminal 100, and at least 2 different movable rescue apparatuses 450-2 and 450-3 around the first movable rescue apparatus 450-1. For example, the movable rescue apparatus 450 can be an additional establishment having the RF module.

Three movable rescue apparatuses 450 are illustrated in FIG. 4. Here, the user terminal 100 can transmit the RF signal having the predetermined frequency band. At this time, information related to the time which it takes to transmit the RF signal (hereinafter, referred to as ‘transmission time’) can be included. Also, the movable rescue apparatus 450 can receive the RF signal including the transmission time and send an RF response signal including information related to the time when the RF signal is received to the rescue center 130. Here, the RF response signal transmitted from the rescue center 130 can include information related to the time when the RF signal is transmitted from the user terminal 100 (hereinafter, referred to as ‘transmission time information’) and/or information related to the time when the RF signal is transmitted to each movable rescue apparatus 450 (hereinafter, referred to as ‘receipt time information’). Alternatively, in accordance with another embodiment of the present invention, the RF response signal can include the attitude of the RF signal and the phase difference of the RF signal.

Accordingly, the rescue center 130 can receive at least 3 RF response signals. Then, the rescue center 130 can compute information related to each distance which the user terminal 100 is away from each movable rescue apparatus 450 (hereinafter, referred to as ‘distance information’) by analyzing each of the transmission time information and the receipt time information of the RF response signal. Alternatively, the rescue center 130 can compute the distance information by measuring the magnitude of the RF response signal.

For example, in order to compute the distance by using time information, the transmission time of the RF response signal can be computed by subtracting the transmission time information from the receipt time information, and if the RF response signal is assumed to be transmitted at the speed of light, the distance information can be evaluated by multiplying the transmission time by the speed of light.

Also, the method of computing the distance information by measuring the magnitude of the RF signal included in the RF response signal can use the property that the magnitude of the RF signal is decreased in proportion to the square of the distance (r²). Here, in the case of ideal vacuum, the magnitude of the RF signal is decreased in proportion to the square of the distance. However, in city environments, the magnitude is decreased in proportion to the cube of the distance (r³) or the distance to the fourth power (r⁴). Accordingly, the distance between each movable rescue apparatus 450 and the user terminal 100 can be computed by measuring the magnitude of the RF signal.

Here, the movable rescue apparatus 450 can compute the distance information to the user terminal 100 by further considering the phase of the received RF signal. In other words, since the phase of the RF signal transmitted to the movable rescue apparatus 450 is varied depending on the distance with the user terminal 100, the movable rescue apparatus 450 can more accurately compute the distance to the user terminal 100 by using the phase of the received RF signal. For example, since the RF signal having the frequency of 500 MHz has the wavelength of approximately 60 m, the distance between the movable rescue apparatus 450 and the user terminal 100 can be more accurately computed by extracting the distance information from the phase of the RF signal.

Of course, since the distance information computed by the aforementioned method is on the-assumption that the RF response signal is neither refracted nor diffused and the environment is in the vacuum state, there may be an error. Accordingly, it is obvious that the increased number of the movable rescue apparatus 450 can make it possible to reduce the error range.

Also, a circle can be assumed to have the center which is the movable rescue apparatus 450 and the radius which is the distance information according to the each movable rescue apparatus 450. At this time, the movable rescue apparatus 450 can determine a position at which a plurality of circles (at this time, the number of circles are the same as that of the movable rescue apparatus 450) is overlapped as the position information. Of course, there may be no position at which a plurality of circles is completely overlapped due to the foregoing error. In this case, the movable rescue apparatus 450 can determine a position at which most circles are overlapped as the position information.

The aforementioned method of allowing the rescue center 130 to generate the position information is merely an example. The method of generating the position information can be varied. Accordingly, the method of generating the position information gives no limit to the spirit and scope of the present invention.

The aforementioned operation of allowing the rescue center 130 to generate the position information can be performed in case that the current position of the user terminal 100 is unable to be recognized. The operation may not be performed in the case of receiving the position information generated by the position information generating unit 270 having a global positioning system (GPS) in accordance with another embodiment of the present invention.

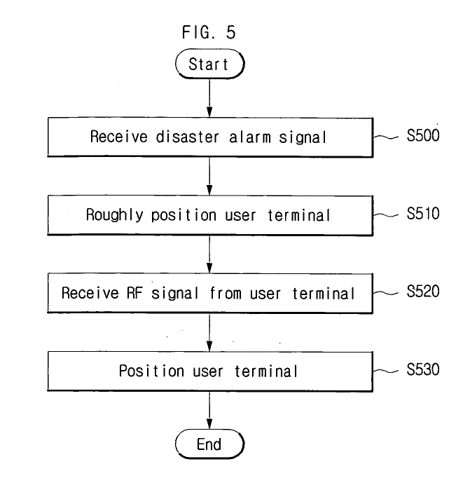

FIG. 5 is a flow chart illustrating a method of rescuing a rescuee in accordance with an embodiment of the present invention.

The method of rescuing a user in danger by receiving an RF signal having a predetermined frequency band through the movable rescue apparatus 450 of the rescue center 130 in accordance with an embodiment of the present invention will be described in detail with reference with FIG. 5.

In a step represented by S500, the rescue center 130 can receive a disaster alarm signal from the disaster informing server 120. The rescue center 130 can receive the disaster alarm signal from the disaster informing server 120 through the communication network 110 or the cell broadcasting service. Also, in accordance with another embodiment of the present invention, the step represented by S500 may be omitted.

In a step represented by S510, the rescue center 130, which has received the disaster alarm signal, can roughly position the user terminal 100 which is located at a disaster area.

The rough position information of the user terminal 100 can be extracted through a visitor location register (VLR) or a home location register (HLR) of a mobile switching center (MSC).

The wireless location determination technology can be used to roughly position the user terminal 100 in a range of the base station unit. The wireless location determination technology has been currently developed toward a direction using the existing network, a direction using a new independent network and a direction using a global positioning system (GPS). The typical method of performing the wireless location determination wireless location determination of these technology developing directions can be divided into a network-based method, a handset based method and a dedicated network-based method. Since each positioning technology is known technology when the present invention is filed, the detailed description related to a part having no relation to the point of the present invention will be omitted.

Here, since the position of the user terminal 100 is recognized in units of the base stations, the RF signal outputted from the user terminal 100 can be received through the movable rescue apparatus 450 including the RF module having a predetermined frequency band by using the rescue center 130 in order to more accurately position the user terminal 100. Also, in accordance with another embodiment of the present invention, the accurate position of a subscriber (i.e. the user terminal 100) can be recognized by being connection with a road name, an administrative distinct name and a distance on a map by accessing a geographic information system (GIS). In a step represented by S520, the rescue center 130 can the RF signal outputted from the user terminal 100 through the movable rescue apparatus 450. Here, the generated RF signal can be a very simple signal such as Morse code. Also, the RF signal can be generated to have very little magnitude in order to use the battery at a minimum

In a step represented by S530, the rescue center 130 can allow a user in danger to be easily rescued by analyzing the RF signal received from the user terminal 100 and accurately positioning the user by use of the movable rescue apparatus 450. The method of positioning the user by using the movable rescue apparatus 450 has been described above with reference to FIG. 4.

In accordance with another embodiment of the present invention, the rescue center 130 can receive an RF signal having position information from the user terminal 100 including a global positioning system to more accurately position the user terminal 100.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalent.

What is claimed is:

1. A method of requesting a rescue by a user terminal connected to a disaster informing server and a rescue center through a communication network, the method comprising:
receiving a disaster alarm signal from the disaster informing server;
generating a corresponding RF signal by receiving the disaster alarm signal; and
outputting the generated RF signal,
whereas the rescue center positions the user terminal by analyzing an RF response signal sent from a movable rescue apparatus including an RF module for receiving the RF signal.

2. The method of claim 1, wherein, in the step of receiving the disaster alarm signal, the disaster alarm signal is received by using a cell broadcasting server.

3. The method of claim 1, wherein, in the step of generating the RF signal, the RF signal includes a rescue message.

4. The method of claim 3, wherein the rescue message includes position information of the user terminal.

5. The method of claim 4, wherein the position information of the user terminal is extracted by using a GPS signal received from a global positioning system (GPS) satellite.

6. The method of claim 1, wherein the RF signal has a predetermined frequency band.

7. The method of claim 6, wherein the predetermined frequency band is not used for mobile communication.

8. The method of claim 1, wherein the rescue center pre-acquires a position of the user terminal in units of base station by receiving the disaster alarm signal from the disaster informing server.

9. The method of claim 1, wherein, in the method of allowing the rescue center to position the user terminal, the rescue center generates position information of the user terminal by using the difference between transmission time information related to a time when the RF signal is transmitted and reception time information related to a time when a movable rescue apparatus receives the RF signal, the transmission time information and the reception time information being included in the RF response signal received from the movable rescue apparatus at a periphery of the user terminal.

10. The method of claim 1, wherein the RF response signal comprises a magnitude of the RF signal, and the rescue center generates position information of the user terminal by measuring a distance between the user terminal and the movable rescue apparatus according to the magnitude of the RF signal received from the movable rescue apparatus at a periphery of the user terminal.

11. The method of claim 10, wherein the magnitude of the RF signal is inversely proportional to any one variable among the square of the distance between the user terminal and the movable rescue apparatus, the cube of the distance between the user terminal and the movable rescue apparatus, and the distance between the user terminal and the movable rescue apparatus, multiplied to the fourth power.

12. The method of claim 10, wherein the RF response signal comprises phase information of the RF signal, and the rescue center generates position information of the user terminal according to the phase information of the RF signal.

13. The method of Clam 9, wherein the number of movable rescue apparatuses is three.

14. A recording medium tangibly embodying a program of instructions executable by a terminal connected to a disaster informing server and a rescue center through a communication network, the recording medium being readable by a digital processing apparatus, the program comprising:
receiving a disaster alarm signal from the disaster informing server;
generating a corresponding RF signal by receiving the disaster alarm signal; and
outputting the generated RF signal,
whereas the rescue center positions the user terminal by analyzing an RF response signal sent from a movable rescue apparatus including an RF module for receiving the RF signal.

15. A terminal connected to a disaster informing server and a rescue center through a communication network, the terminal comprising:
a signal receiving unit, receiving a disaster alarm signal from the disaster informing server;
an RF signal generating unit, generating an RF signal having a predetermined frequency band according to the received disaster alarm signal;
an RF signal output unit, outputting the generated RF signal; and
a terminal control unit, controlling generation and output of the RF signal.

16. The terminal of claim 15, further comprising a position information generating unit generating position information of the user terminal.

17. The terminal of claim 15, wherein the position information generating unit generates the position information by using a GPS signal received from a global positioning system (GPS) satellite.

18. The terminal of claim 15, wherein the signal receiving unit receives the disaster alarm signal by using a cell broadcasting server.

19. The terminal of claim 15, wherein the predetermined frequency band is not used for mobile communication.
